(19) United States
(12) Patent Application Publication
(10) Pub. No.: US 2009/0211069 A1
(43) Pub. Date: Aug. 27, 2009

(54) STRAP RETAINING ASSEMBLY

(76) Inventor: REX J. PETERSON, Manteno, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 12/355,571

(22) Filed: Jan. 16, 2009

Related U.S. Application Data
(60) Provisional application No. 61/031,849, filed on Feb. 27, 2008.

(51) Int. Cl. B25B 25/00

(52) U.S. Cl. 24/69 ST

(57) ABSTRACT

A strap securing assembly is configured to be positioned on a structure and securely retain a strap with respect to the structure. The assembly includes a base configured to abut a surface of the structure. The base has a strap passage formed therethrough. The strap passage is configured to allow a strap to pass into the base. The assembly also includes a lever rotatably secured to the base through a hinge. The lever is configured to rotate with respect to the base and securely crimp portions of the strap between the lever and the base.

### RELATED APPLICATIONS

This application relates to and claims priority benefits from U.S. Provisional Patent Application No. 61/031,849 entitled “One Piece Strap Retainer,” filed Feb. 27, 2008, which is hereby incorporated by reference in its entirety.

### FIELD OF EMBODIMENTS OF THE INVENTION

Embodiments of the present invention generally relate to a strap or cable retaining assembly, and more particularly to a strap or cable retaining assembly that allows for simple and easy installation.

### BACKGROUND

In many applications, straps or cables are used to anchor devices or components to a supporting structure, such as the ground or a floor. The cables may also be ultimately be used for transmission of electrical signals between devices.

A typical retainer assembly includes a plastic washer and a one-way stop that includes a plastic and metal clip. The retainer assembly is used to anchor a cable into the ground. First, a user threads an end of the plastic cable through an anchoring member. The cable is then pulled in order to secure the cable with respect to the anchor. Next, the anchoring member is driven through a mat into the ground to an appropriate depth. A user may then pull on the cable to set it within the ground. The cable may then be trimmed above the mat. After the cable is cut, a plastic washer is positioned over the free end of the cable. The one-way stop is mounted over the washer in order to lock the assembly in place. Simultaneously, the user pulls back on the cable while pushing down on the one-way stop, thereby creating a snug fit with the transition mat against the ground.

### SUMMARY OF EMBODIMENTS OF THE INVENTION

Certain embodiments of the present invention provide a strap securing assembly configured to be positioned on a structure and securely retain a strap with respect to the structure. The strap assembly may include a base and a lever rotatably secured to the base through a hinge.

The base is configured to abut a surface of the structure and includes a first strap passage formed therethrough. The first strap passage is configured to allow a strap to pass into and through the base.

The lever is configured to rotate with respect to the base and securely crimp portions of the strap between the lever and the base in a fully closed position. The lever may include a shroud configured to cover a portion of the strap within the base. The lever may also include a second strap passage that is aligned with the first strap passage when the lever is in a fully open position, wherein the strap is configured to pass into the first and second strap passages.

The base may include a plurality of walls defining a channel. The first strap passage allows a strap to pass into the channel. The base may include a first internal wall that is perpendicular to the strap passage, wherein a portion of the strap is configured to be crimped at a right angle between the strap passage and the first internal wall. The base may also include a second internal wall that is perpendicular to the first internal wall and parallel with the strap passage, wherein a portion of the strap is configured to be crimped at a right angle between the first internal wall and the second internal wall.

The lever or the base may include at least one latch, while the other of the lever or the base may include a reciprocal portion configured to latchably secure to the at least one latch. The at least one latch may include two latches separated from each other by a cavity. A portion of the strap is configured to be trapped within the cavity when the lever is securely closed with respect to the base. The latch(es) may extend from an end of the lever and the reciprocal portion may include at least one latch receptacle formed through the base. Alternatively, the latch(es) may extend from a surface of the base and the reciprocal portion may include a lateral edge of an extension beam of the lever.

The assembly may be configured to allow a free end of the strap to pass therethrough in a direction that is perpendicular or parallel to a plane of the surface of the structure to which the base is secured.

Certain embodiments of the present invention provide a strap securing assembly that includes a strap, a base and a lever. The strap has a first end anchored into or onto a structure and a second end that is free.

The base is configured to abut a surface of the structure or a mat over the structure. The base has a first strap passage formed therethrough. A portion of the strap is positioned within the strap passage.

The lever is rotatably secured to the base through a hinge. The lever rotates with respect to the base and securely crimps the strap between the lever and the base at a plurality of right angles.

### BRIEF DESCRIPTION OF SEVERAL VIEWS OF THE DRAWINGS

FIG. 1 illustrates a top view of a strap retaining assembly, according to an embodiment of the present invention.

FIG. 2 illustrates a side view of a strap retaining assembly, according to an embodiment of the present invention.

FIG. 3 illustrates a bottom view of a strap retaining assembly, according to an embodiment of the present invention.

FIG. 4 illustrates an isometric top view of a strap retaining assembly receiving a strap, according to an embodiment of the present invention.

FIG. 5 illustrates an isometric top view of a strap retaining assembly in a strap securing position, according to an embodiment of the present invention.

FIG. 6 illustrates a cross-sectional view of a strap retaining assembly through line 6-6 of FIG. 5, according to an embodiment of the present invention.

FIG. 7 illustrates a top view of a strap retaining assembly, according to an embodiment of the present invention.

FIG. 8 illustrates a side view of a strap retaining assembly, according to an embodiment of the present invention.

FIG. 9 illustrates an isometric top view of a strap retaining assembly receiving a strap, according to an embodiment of the present invention.

FIG. 10 illustrates an isometric top view of a strap retaining assembly in a strap securing position, according to an embodiment of the present invention.

FIG. 11 illustrates a cross-sectional view of a strap retaining assembly through line 11-11 of FIG. 10, according to an embodiment of the present invention.

FIG. 12 illustrates an isometric top view of a strap retaining assembly in a strap securing position, according to an embodiment of the present invention.

FIG. 13 illustrates a top view of a strap retaining assembly, according to an embodiment of the present invention.

FIG. 14 illustrates a side view of a strap retaining assembly, according to an embodiment of the present invention.

FIG. 15 illustrates an isometric top view of a strap retaining assembly receiving a strap, according to an embodiment of the present invention.

FIG. 16 illustrates an isometric top view of a strap retaining assembly in a strap securing position, according to an embodiment of the present invention.

FIG. 17 illustrates a cross-sectional view of a strap retaining assembly through line 17-17 of FIG. 16, according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE INVENTION

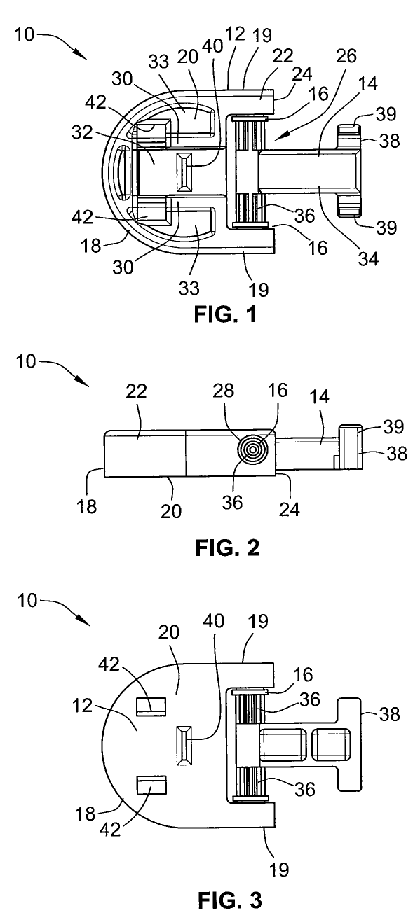

FIGS. 1 and 2 illustrate top and side views, respectively, of a strap retaining assembly 10, according to an embodiment of the present invention. The assembly 10 includes a base 12 and a lever 14 rotatably secured to the base 12 through a hinge 16.

The base 12 includes a front wall 18 integrally connected to straight lateral beams 19. The front wall 18 and lateral beams 19 are integrally formed and connected with a lower wall 20, a top wall 22 and a rear wall 24. The front wall 18 may be curved or rounded. Optionally, the base 12 may be formed in various other shapes, such as a rectangle, square or triangle.

A hinge cavity 26 is formed in the rear wall 24. Further, hinge retaining openings 28 may be formed through the lateral beams 19 on either side of the hinge cavity 26.

Upright walls 30 extend from the front wall 18 to the hinge cavity 26. A channel 32 is defined between the upright walls 30, while latch cavities 33 are formed on sides of the upright walls 30 that are opposite the channel 32.

The lever 14 includes a main beam 34 connected to a hinge bar 36 at one end and a latch bar 38 at an opposite end. The hinge bar 36 is rotatably secured within the hinge retaining openings 28. The hinge 16 including the hinge bar 36 secured within the hinge retaining openings 28 may be similar to that described in U.S. Pat. No. 6,053,458, entitled “Swivel Hinge for a Clip,” which issued Apr. 25, 2000, and is hereby incorporated by reference in its entirety. Optionally, any type of hinge assembly may be used.

Latches 39 extend from opposite ends of the latch bar 38. The latches 39 are configured to be latchably retained within latch receptacles 42 formed through the base 12.

FIG. 3 illustrates a bottom view of the strap retaining assembly 10, according to an embodiment of the present invention. A strap passage 40 and the latch receptacles 42 are formed through the base 12. Referring to FIGS. 1 and 3, the strap passage 40 is located within the channel 32 between the walls 30, while the latch receptacles 42 are located in the latch cavities 33 to the sides of the walls 30, opposite the channel 32, and proximate the front wall 18.

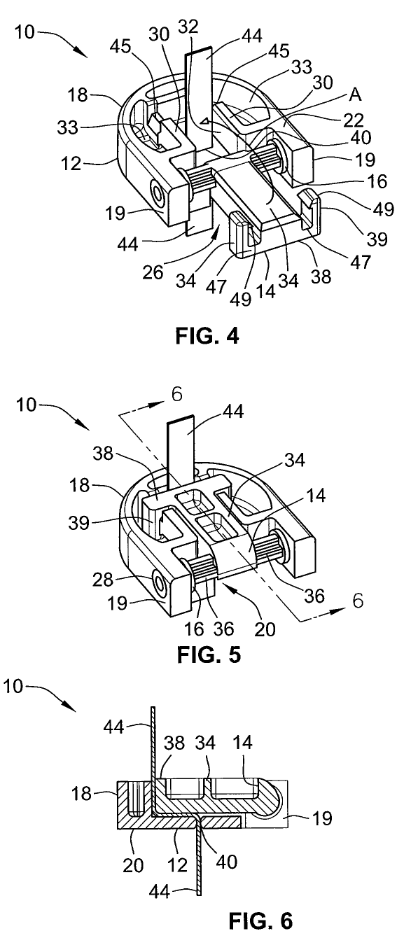

FIG. 4 illustrates an isometric top view of the strap retaining assembly 10 receiving a strap 44, according to an embodiment of the present invention. One end of the strap 44 may be positioned through a mat (not shown) and anchored in the ground (not shown). Referring to FIGS. 1, 3 and 4, the free end of the strap 44 is passed through the strap passage 40. The strap 44 is then pulled through the base 12 to a desired length. It is to be understood, that instead of a strap, the assembly 10 may be configured for use with a cable or the like instead. The assembly 10 is then positioned on the mat (or ground) so that the lower wall 20 abuts a top surface of the mat (or ground).

In order to secure the strap 44 in place, the lever 14 is rotated onto the base 12. The upright walls 30 include divots 45 proximate the front wall 18. The divots 45 are configured to allow the latch bar 38 to seat above the walls 30. As shown in FIG. 4, the latches 39 secure to the main beam 34 through beams 47 that are not as thick as the main beam 34. Thus, channels are formed between the main beam 34 and the latches 39. When the lever 14 is rotated over the base 12 and secured in place, these channels are positioned over the divots 45 formed in the walls 30. Further, as shown in FIG. 4, the latches 39 include distal clasps 49 that are configured to be received and retained by reciprocal features of the latch receptacles 42.

FIG. 5 illustrates an isometric top view of the strap retaining assembly 10 in a strap securing position, according to an embodiment of the present invention. As shown in FIG. 5, the lever 14 has been rotated onto the base 12 by way of the hinge bar 36 rotating through the hinge retaining openings 28, such as described, for example, in U.S. Pat. No. 6,054,458. As the lever 14 rotates into the channel 32 (shown in FIGS. 1 and 4), the main beam 34 of the lever 14 flattens a portion of the strap 44 against a top surface of the lower wall 20 (shown in FIGS. 1-3), while the latch bar 38 compresses an adjacent portion of the strap 44 against an interior surface of the front wall 18. The latches 39 latchably secure within the latch receptacles 42 (shown in FIGS. 1 and 3). That is, the latches 39 may latch onto reciprocal features that define the latch receptacles 42. When the latches 39 securely latch into the latch receptacles 42, the strap 44 is securely crimped within the base 12, thereby preventing it from shifting or moving with respect to the base 12.

FIG. 6 illustrates a cross-sectional view of the strap retaining assembly 10 through line 6-6 of FIG. 5. As shown in FIG. 6, in the secured position, the strap 44 passes into the base 12 through the strap passage 40 and is compressed against an upper surface of the lower wall 20 by the main beam 34. An adjacent portion of the strap 44 is further compressed into an interior surface of the front wall 18 by the latch bar 38. As such, the strap 44 is securely crimped within the base 12 of the assembly 10. The assembly crimps the strap 44 at two 90° angles, thereby providing a secure hold on the strap 44.

As shown, the strap 44 enters underneath the assembly 10 and exits above the assembly 10. In this manner, the directions of ingress and egress are generally perpendicular to a ground surface. Certain applications may be better suited for other arrangements, however. Thus, embodiments of the present invention may be configured to allow the strap 44 to exit the assembly 10 in a direction that is generally parallel to the ground surface.

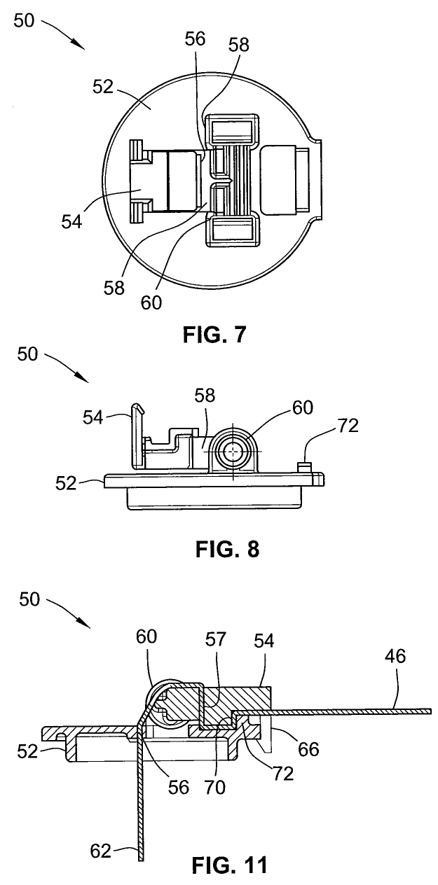

FIGS. 7 and 8 illustrate top and side views, respectively, of a strap retaining assembly 50, according to an embodiment of the present invention. Similar to the assembly 10, the assembly 50 includes a base 52 and a lever 54. The base 52 may be circular, as shown in FIG. 7, and configured to be positioned within a reciprocal hole formed through a mat, panel, ground or the like. The assembly 50 is similar to the assembly 10, except that the assembly 50 is configured to allow a strap to exit in a direction that is generally parallel with a ground surface or other such surface that the base 52 abuts.

A strap passage 56 is formed through the base 52 and is positioned underneath and between hinge panels 58 of the lever 54. That is, the hinge panels 58 may include cylindrical posts that secure within reciprocal openings formed in the hinge 60. Again, the hinge 60 may operate similar to that described in U.S. Pat. No. 6,053,458. Optionally, the lever 54 may include a strap passage 56 formed through a lower stem portion proximate the hinge 60 and aligned with the strap passage 56.

The hinge panels 58 are rotatably secured to the hinge 60. A strap 62 may be passed into the assembly 10 so that is passes through the strap passage 56 (and an aligned strap passage formed through the lever 54).

As shown in FIG. 8, the base 52 may include a recessed annular plug 53 configured to be secured in a reciprocal socket or opening formed in a mat that covers a surface.

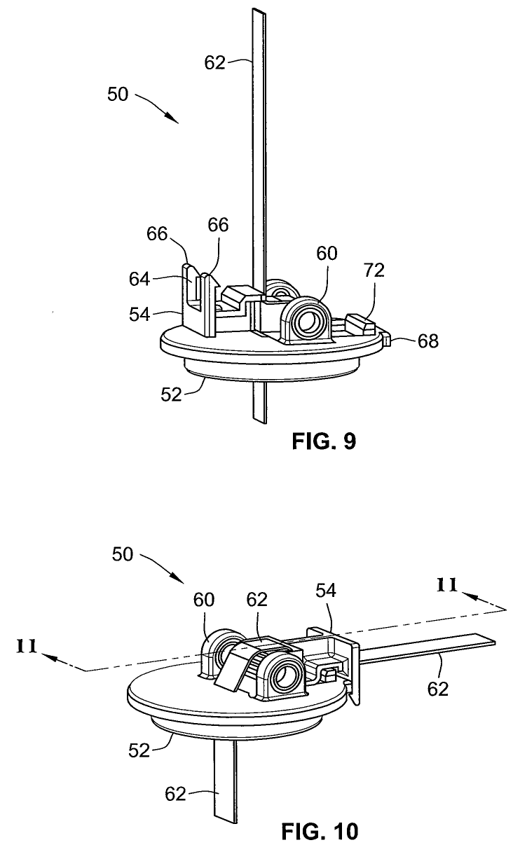

FIG. 9 illustrates an isometric top view of the strap retaining assembly 50 receiving the strap 62, according to an embodiment of the present invention. A free end of the strap 44 is passed into and through the strap passage 56 formed in the base 52 and between the hinge panels 58 of the lever 54. In order to secure the strap 44 in place, the lever 54 is rotated over the base 52 such that the strap 54 is trapped within a cavity 64 defined between two latches 66. The latches 66 are configured to latchably secure to an outer edge 68 of the base 52.

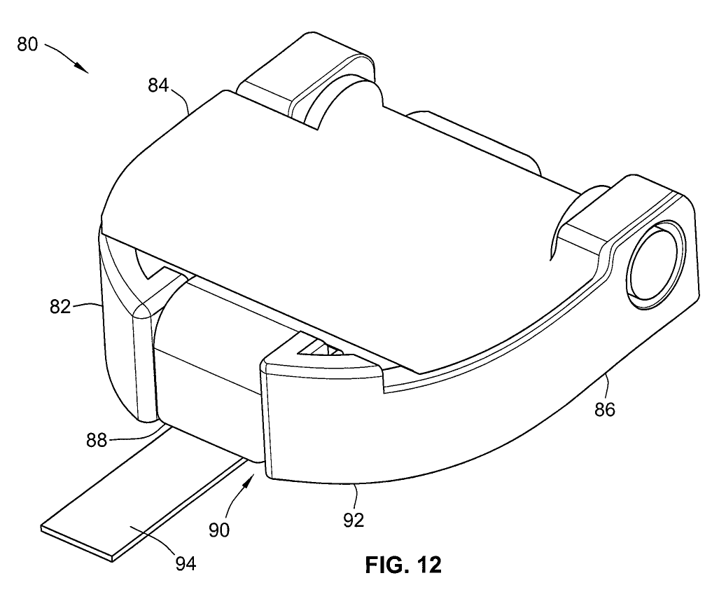

FIG. 10 illustrates an isometric top view of the strap retaining assembly 50 in a strap securing position, according to an embodiment of the present invention. In this position, the strap 44 is pulled over the hinge 60 by way of the lever 544. That is, as the lever 54 is rotated, the strap 44, because it is trapped within the cavity 64 between the latches 66, bends over the hinge 60 and exits out of the assembly 50 through the cavity 64 in a direction that is parallel to the main upper surface of the base 52.

FIG. 11 illustrates a cross-sectional view of a strap retaining assembly 50 through line 11-11 of FIG. 10. As shown in FIG. 11, the strap 62 passes through the strap passage 56 and a strap channel 57 that may be formed through the lever 54 (both of these passages being aligned when the lever 54 is in the fully open position). As such, when the lever 54 is rotated into the close position, the strap 62 is crimped with respect to the lever 54 through a series of right angle turns. As shown, the strap 62 passes over the hinge 60 and into the strap channel 57 at a right angle. The strap 62 exits the strap channel 57 at a right angle, at which point it is compressed into an upper surface of the base 52. The strap 62 is crimped within and between the lever 54 and upwardly-protruding right angle surfaces 70 of the base 52. For example, the base 52 may include an upstanding block 72 that provides such surfaces 70. In this manner, the strap 62 is crimped through a plurality of right angles and passes through the cavity 64 (shown in FIG. 9) of the lever 54 at a direction that is generally parallel to the ground. Further, the latches 66 include clasps that snapably secure over the outer edge 68 of the base 52.

The embodiments shown and described in FIGS. 7-11 cinch the strap 62 as it is folded over the base 52, by way of the lever 54. That is, the strap 62 is secured within the lever 54 and, as the lever 54 is rotated over the base 52, the lever automatically cinches the strap 62, thereby holding the strap 62 tighter with respect to the assembly 50 and a structure to which the assembly 50 is secured.

FIG. 12 illustrates an isometric top view of a strap retaining assembly 80 in a strap securing position, according to an embodiment of the present invention. The assembly 80 is similar to the assembly 10. However, the lever 84 includes a shroud 86 that covers the interior of the base 82. A crimped tab 88 extends from a distal end of the lever 84 and is configured to be positioned over a strap passage 90 formed through a front wall 92 of the base 82. In this manner, the shroud 86 guides the strap 94 into an exiting direction that is parallel to a surface of the ground (or other object to which the base 82 abuts).

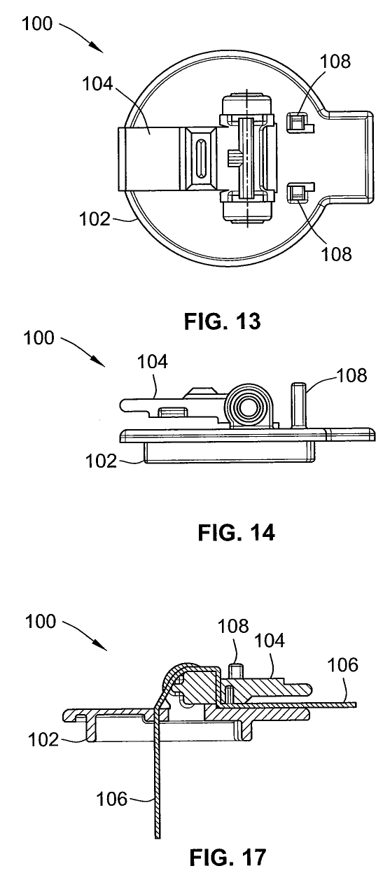

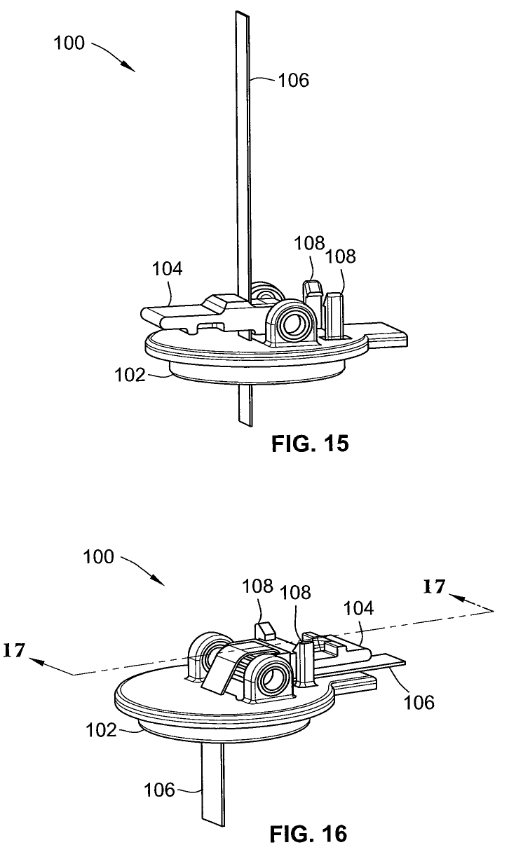

FIG. 13 illustrates a top view of a strap retaining assembly 100, according to an embodiment of the present invention. FIG. 14 illustrates a side view of the strap retaining assembly 100. FIG. 15 illustrates an isometric top view of the strap retaining assembly 100 receiving a strap 106, according to an embodiment of the present invention. FIG. 16 illustrates an isometric top view of the strap retaining assembly 100 in a strap securing position. FIG. 17 illustrates a cross-section view of the strap retaining assembly 100 through line 17-17 of FIG. 16.

Referring to FIGS. 13 and 17, the assembly 100 is similar to the assembly 50, except that the lever 104 does not include the latches. Instead, the opposing latches 108 extend from an upper surface of the base 102 and are configured to snapably secure onto outer lateral edges of the lever 104, as shown in FIGS. 16 and 17.

The embodiments of the present invention discussed above provide a strap or cable securing assembly that may be manufactured as a single piece. Thus, an installation process is made simpler due to the fact that a user does not need to separately assemble a one-way stop to a plastic washer. Instead, the assemblies discussed in FIGS. 1-17 provide a single piece that performs all securing functionality.

Moreover, the assemblies provide a plurality of 90° crimps when in closed positions that securely retain the straps within the assemblies. As such, the straps are less likely to slip through the assemblies.

Embodiments of the present invention may be formed in various shapes, sizes and configurations. Further, aspects of each embodiment may be interchanged with various other embodiments. For example, the embodiments shown and described with respect to FIGS. 1-6 may include an auto-cinching lever, such as shown and described in FIGS. 7-17. Additionally, embodiments of the present invention may be configured to allow the strap to pass in a direction that is generally parallel or perpendicular to the plane of a surface to which the assemblies are secured. Also, in any of the embodiments, the latches may be located on the lever or the base. For example, the embodiments shown and described with respect to FIGS. 7-12 may include a base having latches that latchably secure to lateral edges of the lever.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A strap securing assembly configured to be positioned on a structure and securely retain a strap with respect to the structure, the strap securing assembly comprising:
a base configured to abut a surface of the structure, said base having a first strap passage formed therethrough, said first strap passage configured to allow a strap to pass into said base; and
a lever rotatably secured to said base through a hinge, said lever configured to rotate with respect to said base and securely crimp portions of the strap between said lever and said base.

2. The assembly of claim 1, said base comprising a plurality of walls defining a channel, wherein said first strap passage allows a strap to pass into said channel.

3. The assembly of claim 1, wherein one of said lever or said base comprises at least one latch, the other of said lever or said base comprising a reciprocal portion configured to latchably secure to said at least one latch.

4. The assembly of claim 3, wherein said at least one latch comprises two latches separated from each other by a cavity, and wherein a portion the strap is configured to be trapped within said cavity when said lever is securely closed with respect to said base.

5. The assembly of claim 3, wherein said at least one latch extends from an end of said lever and said reciprocal portion comprises at least one latch receptacle formed through said base.

6. The assembly of claim 3, wherein said at least one latch extends from a surface of said base and said reciprocal portion comprises a lateral edge of an extension beam of said lever.

7. The assembly of claim 1, said base comprising a first internal wall that is perpendicular to said strap passage, wherein a portion of the strap is configured to be crimped at a right angle between said strap passage and said first internal wall.

8. The assembly of claim 7, said base comprising a second internal wall that is perpendicular to said first internal wall and parallel with said strap passage, wherein a portion of the strap is configured to be crimped at a right angle between said first internal wall and said second internal wall.

9. The assembly of claim 1, wherein the assembly is configured to allow a free end of the strap to pass therethrough in a direction that is perpendicular to a plane of the surface of the structure to which said base is secured.

10. The assembly of claim 1, wherein the strap is configured to exit from the assembly in a direction that is parallel to a plane of the surface of the structure to which said base is secured.

11. The assembly of claim 1, said lever comprising a shroud configured to cover a portion of the strap within said base.

12. The assembly of claim 1, said lever comprising a second strap passage that is aligned with said first strap passage when said lever is in a fully open position, wherein the strap is configured to pass into said first and second strap passages.

13. A strap securing assembly comprising:
a strap having a first end anchored into or onto a structure and a second end that is free;
a base configured to abut a surface of the structure or a mat over the structure, said base having a first strap passage formed therethrough, a portion of said strap being positioned within said strap passage; and
a lever rotatably secured to said base through a hinge, said lever rotating with respect to said base and securely crimping said strap between said lever and said base at a plurality of right angles.

14. The assembly of claim 13, said base comprising a plurality of walls defining a channel, wherein said strap passes into said channel through strap passage.

15. The assembly of claim 13, wherein one of said lever or said base comprises at least one integral latch, the other of said lever or said base comprising an integral reciprocal portion configured to latchably secure to said at least one latch when said lever is in a fully closed position with respect to said base

16. The assembly of claim 15, wherein said at least one latch comprises two latches separated from each other by a cavity, and wherein a portion the strap is trapped within said cavity when said lever is securely closed with respect to said base.

17. The assembly of claim 15, wherein said at least one latch extends from an end of said lever and said reciprocal portion comprises at least one latch receptacle formed through said base.

18. The assembly of claim 15, wherein said at least one latch extends from a surface of said base and said reciprocal portion comprises a lateral edge of an extension beam of said lever.

19. The assembly of claim 13, said base comprising a first internal wall that is perpendicular to said strap passage, wherein a first portion of said strap is crimped at a right angle between said strap passage and said first internal wall when said lever is in a fully closed position with respect to said base.

20. The assembly of claim 19, said base comprising a second internal wall that is perpendicular to said first internal wall and parallel with said strap passage, wherein a second portion of said strap is crimped at a right angle between said first internal wall and said second internal wall when said lever is in a fully closed position with respect to said base.

21. The assembly of claim 13, wherein said strap exits the assembly in a direction that is perpendicular or parallel to a plane of the surface of the structure to which said base is secured.

22. The assembly of claim 13, said lever comprising a shroud that covers a portion of said strap within said base when said lever is in a fully closed position with respect to said base.

23. The assembly of claim 1, said lever comprising a second strap passage that is aligned with said first strap passage when said lever is in a fully open position, wherein said strap is positioned through said first and second strap passages.

24. A strap securing assembly configured to be positioned on a structure and securely retain a strap with respect to the structure, the strap securing assembly comprising:
a base configured to abut a surface of the structure, said base having a first strap passage formed therethrough, said first strap passage configured to allow a strap to pass into said base, said base comprising a first internal wall and a second internal wall, said first internal wall being perpendicular to said first strap passage, wherein a first portion of the strap is configured to be crimped at a right angle between said strap passage and said first internal wall, said second internal wall being perpendicular to said first internal wall and parallel with said strap passage, wherein a second portion of the strap is configured to be crimped at a right angle between said first internal wall and said second internal wall;
a lever rotatably secured to said base through a hinge, said lever configured to rotate with respect to said base and securely crimp a strap between said lever and said base; and
wherein one of said lever or said base comprises two opposing latches separated from one another by a cavity, the other of said lever or said base comprising an integral reciprocal portion configured to latchably secure to said at two latches, wherein a portion the strap is configured to be trapped within said cavity when said lever is securely closed with respect to said base, wherein the assembly is configured to allow a free end of the strap to pass therethrough in a direction that is perpendicular or parallel to a plane of the surface of the structure to which said base is to be secured.

25. The assembly of claim 24, said base comprising a plurality of walls defining a channel, wherein said strap passage allows a strap to pass into said channel.

26. The assembly of claim 24, wherein said latches extend from an end of said lever and said reciprocal portion comprises at least one latch receptacle formed through said base.

27. The assembly of claim 24, wherein said latches extend from a surface of said base and said reciprocal portion comprises a lateral edge of an extension beam of said lever.

28. The assembly of claim 24, said lever comprising a shroud configured to cover a portion of the strap within said base.

29. The assembly of claim 24, said lever comprising a second strap passage that is aligned with said first strap passage when said lever is in a fully open position, wherein the strap is configured to pass into said first and second strap passages.
